(19) United States
(12) Patent Application Publication
(10) Pub. No.: US 2026/0261918 A1
(43) Pub. Date: Sep. 3, 2026

(54) METHOD AND APPARATUS FOR IDENTIFICATION RELATED TO ROAMING IN WIRELESS LAN SYSTEM

(71) Applicant: LG ELECTRONICS INC., Seoul (KR)

(72) Inventors: Yelin YOON, Seoul (KR); Insun JANG, Seoul (KR); Jinsoo CHOI, Seoul (KR); Sunhee BAEK, Seoul (KR); Geonhwan KIM, Seoul (KR)

(73) Assignee: LG ELECTRONICS INC., Seoul (KR)

(21) Appl. No.: 19/489,464

(22) PCT Filed: Jun. 21, 2024
(86) PCT No.: PCT/KR2024/008615

§ 371 Date: Dec. 2, 2025

(30) Foreign Application Priority Data
Jun. 21, 2023 (KR) 10-2023-0079851
Jun. 22, 2023 (KR) 10-2023-0080494

(51) Int. Cl. H04W 36/00; H04W 36/08; H04W 60/04

(52) U.S. Cl. CPC H04W 36/0016; H04W 36/00835; H04W 36/08; H04W 60/04

(57) ABSTRACT

The present disclosure relates to identification related to roaming in a wireless LAN system. According to an embodiment of the present disclosure, a method performed by a mobile device in a wireless LAN system comprises the steps of performing a connection procedure with a first access point (AP) affiliated with a first multi-link device (MLD); acquiring a group identifier (ID) of a roaming group including the first MLD; transmitting, to a second MLD included in the roaming group, a request frame for requesting roaming, the request frame including the group ID; and on the basis of receiving a response frame including the group ID, performing roaming by means of the second MLD.

### CROSS-REFERENCE TO RELATED APPLICATION(S)

This application is the National Stage filing under 35 U.S.C. 371 of International Application No. PCT/KR2024/008615, filed on Jun. 21, 2024, which claims the benefit of earlier filing date and right of priority to Korean Application Nos. 10-2023-0079851, filed on Jun. 21, 2023, and 10-2023-0080494, filed on Jun. 22, 2023, the contents of which are all incorporated by reference herein in their entirety

### TECHNICAL FIELD

The present disclosure is related to identification related to roaming in a wireless local area network (WLAN) system.

### BACKGROUND

Next-generation Wi-Fi (e.g., IEEE 802.11be and/or later) aims to support ultra-high reliability in signaling to STAs, and various technologies are being considered to support high throughput, low latency, and extended range. To perform seamless roaming, identification related to roaming may be required.

### SUMMARY

An aspect of the present disclosure is to provide method and apparatus for identification related to roaming in a WLAN system.

According to an embodiment of the present disclosure, a method performed by a mobile device in a wireless local area network (LAN) system comprises: performing an association procedure with a first access point (AP) affiliated with a first multi-link device (MLD); obtaining a group identifier (ID) of a roaming group including the first MLD; transmitting a request frame requesting roaming to a second MLD included in the roaming group, the request frame including the group ID; and performing a roaming to the second MLD based on receiving a response frame including the group ID.

According to an embodiment of the present disclosure, a method performed by a first access point (AP) affiliated with a first multi-link device (MLD) in a wireless local area network (LAN) system comprises: performing an association procedure with a mobile device; transmitting a group identifier (ID) of a roaming group including the first MLD to the mobile device; receiving, from the mobile device, a request frame requesting roaming to a second MLD included in the roaming group, the request frame including the group ID; and transmitting a response frame including the group ID to the mobile device so that the mobile device performs a roaming to the second MLD.

In various embodiments, apparatuses implementing the above methods are provided.

The present disclosure may have various advantageous effects.

For example, when a non-AP MLD roams, it can check whether the target AP MLD is included in the same roaming group as the AP MLD with which the non-AP MLD has currently established a link, and the number of APs to which roaming can be performed can be increased.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a transmitting apparatus and/or receiving apparatus of the present disclosure.

FIG. 2 is a conceptual view illustrating the structure of a wireless local area network (WLAN).

FIG. 3 illustrates a general link setup process.

FIG. 4 shows an example of a multi-link (ML).

FIG. 5 shows a modified example of a transmitting device and/or a receiving device of the present disclosure.

FIG. 6 shows an example of a physical protocol data unit or physical layer (PHY) protocol data unit (PPDU) transmitted/received by an STA of the present disclosure.

FIG. 7 illustrates the layout of resource units (RUs) used for a 20 MHz PPDU.

FIG. 8 illustrates the layout of resource units (RUs) used for 40 MHz PPDU.

FIG. 9 illustrates the layout of resource units (RUs) used for an 80 MHz PPDU.

FIG. 10 shows an operation related to UL-MU.

FIG. 11 illustrates an example of channels used/supported/defined within the 2.4 GHz band.

FIG. 12 illustrates an example of channels used/supported/defined within the 5 GHz band.

FIG. 13 illustrates an example of channels used, supported, and defined within the 6 GHz band.

FIG. 14 shows an example of a MAC frame header.

FIG. 15 shows the high-level architecture of the AP MLD.

FIG. 16 shows the deployment of AP MLDs for roaming.

FIG. 17 shows an example of a method performed by a mobile device for identification related to roaming according to an embodiment of the present disclosure.

FIG. 18 shows an example of a method performed by an AP for identification related to roaming according to an embodiment of the present disclosure.

FIG. 19 shows a first example of the format of an RNR IE including MLD roaming information according to an embodiment of the present disclosure.

FIG. 20 shows a second example of the format of an RNR IE including MLD roaming information, according to an embodiment of the present disclosure.

FIG. 21 shows an example of a multi-link probe request/response based on the Group-managing AP MLD ID and/or the Group-member AP MLD ID, according to an embodiment of the present disclosure.

### DETAILED DESCRIPTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

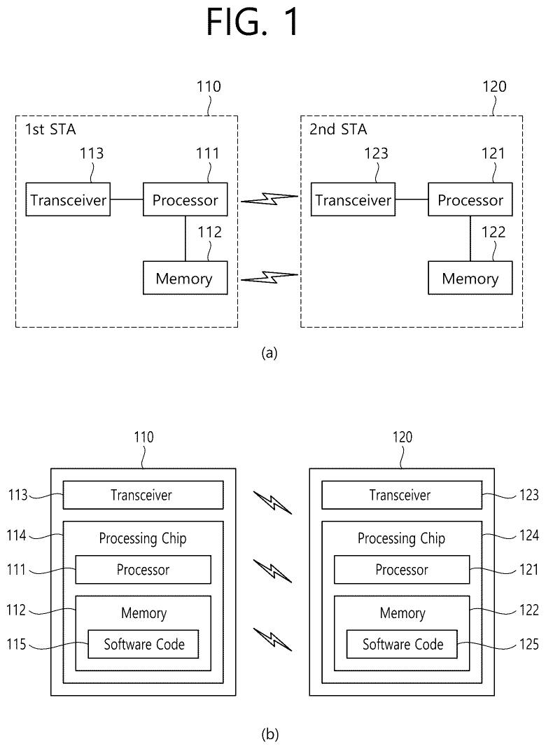

FIG. 1 shows an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON® series of processors made by Qualcomm®, EXYNOS® series of processors made by Samsung®, A series of processors made by Apple®, HELIO® series of processors made by MediaTek®, ATOM® series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

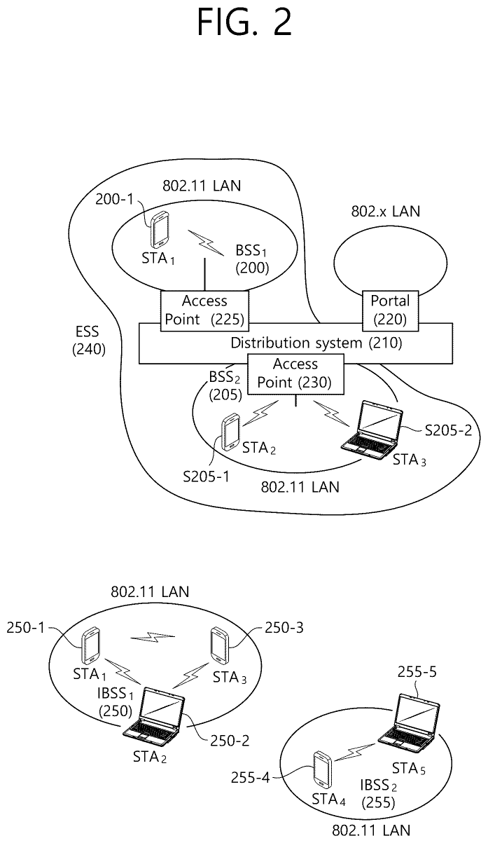

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

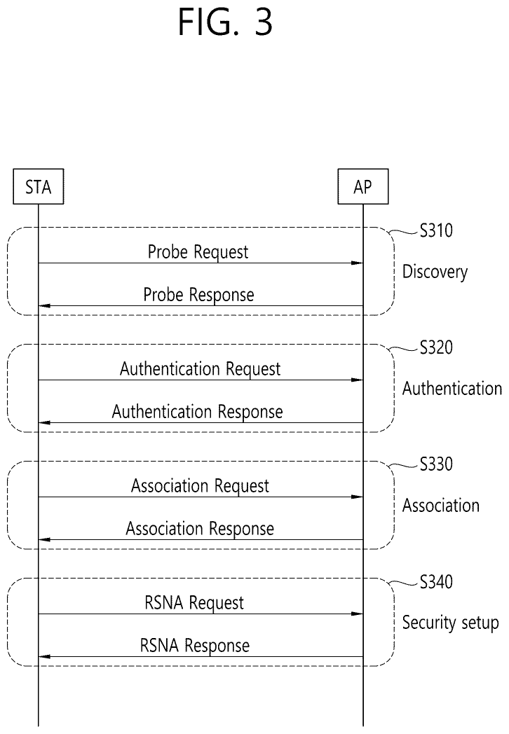

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

Below, multi-link (ML) is described.

Terms related to multi-link are defined as follows:
A multi-link device (MLD) can support multiple affiliated STAs, operate using one or more affiliated STAs, and provide a single MAC data service and a single MAC service access point (SAP) to the logical link control (LLC) lower layer.
Multi-link operation (MLO) may refer to tasks such as discovery, authentication, multi-link setup, and frame exchange between two MLDs;
An affiliated STA is a STA that provides link-specific lower-level MAC and PHY services within an MLD. It may be an access point (AP) STA or a non-access point (non-AP) STA;
An AP MLD is an MLD in which each affiliated STA is an AP;
A non-AP MLD is an MLD in which each affiliated STA is a non-AP STA;
An affiliated AP is an AP STA affiliated with an AP MLD;
An affiliated non-AP STA is a non-AP STA affiliated with a non-AP MLD.

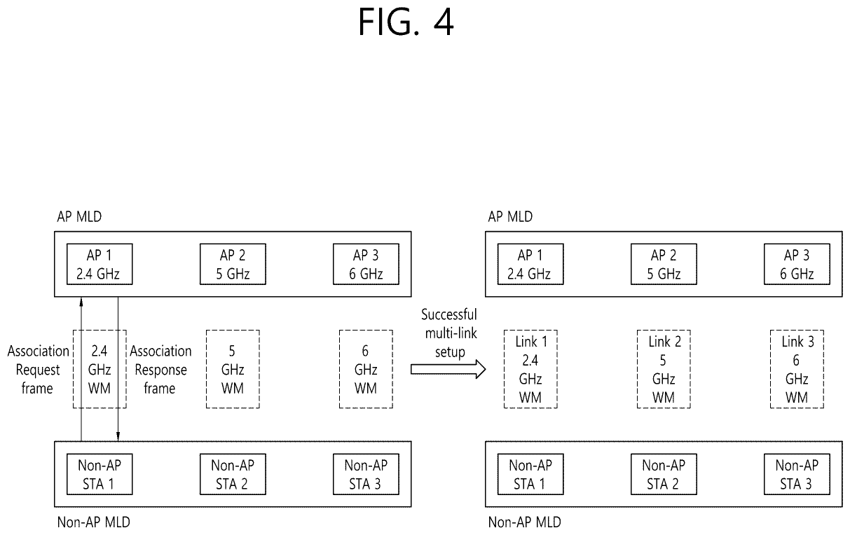

FIG. 4 shows an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHz, 5 GHz, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

Once ML setup is completed, an enabled link for ML communication may be determined. A STA may exchange frames through at least one of the multiple links determined as enabled links. For example, an enabled link can be used for at least one of a management frame, a control frame, or a data frame.

If a single STA supports multiple links, the transmitting and receiving devices supporting each link can operate as a single logical STA. For example, a single STA supporting two links can be represented by a single Multi-Link Device (MLD) that includes a first STA for the first link and a second STA for the second link. For example, a single AP supporting two links can be represented by a single AP MLD that includes a first AP for the first link and a second AP for the second link. Furthermore, a non-AP supporting two links can be represented by a non-AP MLD that includes a first STA for the first link and a second STA for the second link.

More specific features regarding ML setup are described below.

An MLD (AP MLD and/or non-AP MLD) can transmit information about links that the MLD can support through ML setup. The information about the links can be configured in various ways. For example, the information about the links can include at least one of 1) information about whether the MLD (or STA) supports simultaneous RX/TX operation, 2) information about the number/upper limit of uplink/downlink links supported by the MLD (or STA), 3) information about the location/band/resource of uplink/downlink links supported by the MLD (or STA), 4) information about the type of frame (management, control, data, etc.) available or preferred in at least one uplink/downlink Link, 5) information about ACK policy available or preferred in at least one uplink/downlink Link, and 6) information about a traffic identifier (TID) available or preferred in at least one uplink/downlink Link. TID is related to the priority of traffic data and is expressed as eight types of values according to the existing wireless LA STAndard. That is, eight TID values can be defined corresponding to four access categories (AC) (AC_BK (background), AC_BE (best effort), AC_VI (video), AC_VO (voice)) according to the existing wireless LAN standard.

For example, all TIDs can be pre-configured to be mapped to uplink/downlink links. Specifically, if negotiation is not achieved through ML setup, all TIDs are used for ML communication. If the mapping between uplink/downlink links and TIDs is negotiated through additional ML setup, the negotiated TID can be used for ML communication.

Through ML setup, multiple links can be established for use by the transmitting and receiving MLDs involved in ML communication, and these can be referred to as “enabled links.” An “enabled link” can be referred to in various ways, such as “First Link,” “Second Link,” “Transmit Link,” or “Receive Link.”

After ML setup is completed, the MLD can update the ML setup. For example, if link information needs to be updated, the MLD can transmit information about the new link. Information about the new link can be transmitted based on at least one of a management frame, a control frame, or a data frame.

The specific features of the present disclosure are not limited to the specific features of FIG. 4. That is, the number of links can be defined in various ways, and multiple links can be defined in various ways within at least one band.

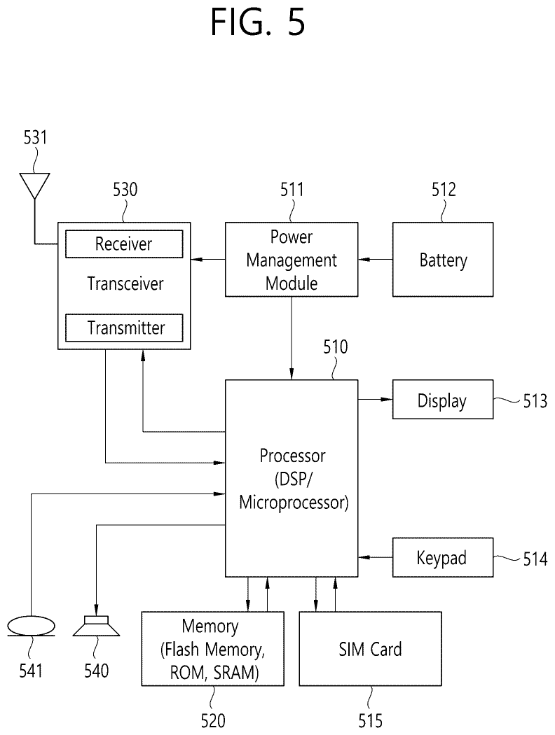

FIG. 5 shows a modified example of a transmitting device and/or a receiving device of the present disclosure.

The devices (e.g., AP STA, non-AP STA) shown in FIGS. 1 to 4 can be modified as shown in FIG. 5. The transceiver 530 of FIG. 5 can be identical to the transceiver 113, 123 of FIG. 1. The transceiver 530 of FIG. 5 can include a receiver and a transmitter.

The processor 510 of FIG. 5 can be identical to the processor 111, 121 of FIG. 1. Alternatively, the processor 510 of FIG. 5 can be identical to the processing chip 114, 124 of FIG. 1.

The memory 150 of FIG. 5 may be the same as the memory 112, 122 of FIG. 1. Alternatively, the memory 150 of FIG. 5 may be a separate external memory different from the memory 112, 122 of FIG. 1.

Referring to FIG. 5, the power management module 511 manages power for the processor 510 and/or the transceiver 530. The battery 512 supplies power to the power management module 511. The display 513 outputs the result processed by the processor 510. The keypad 514 receives input to be used by the processor 510. The keypad 514 may be displayed on the display 513. The SIM card 515 may be an integrated circuit used to securely store an international mobile subscriber identity (IMSI) and its associated keys, which are used to identify and authenticate subscribers in mobile devices such as mobile phones and computers.

Referring to FIG. 5, the speaker (540) may output sound-related results processed by the processor 510. The microphone (541) may receive sound-related input to be used by the processor 510.

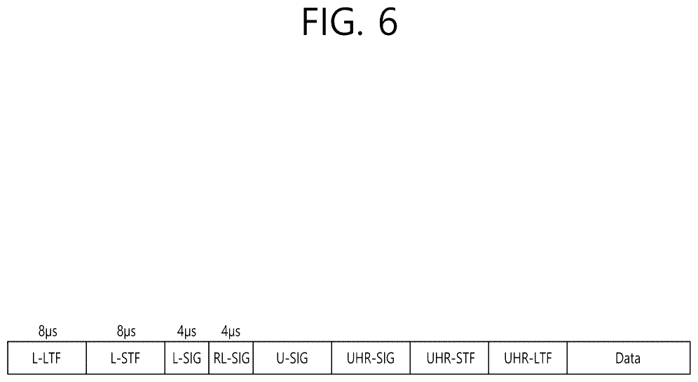

FIG. 6 shows an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 6. The PPDU described in the present disclosure can have, for example, a structure of FIG. 6. In addition, the PPDU described in the present disclosure can be called by various names such as a transmission PPDU, a reception PPDU, a first type or an Nth type PPDU, etc. The PPDU described in the present disclosure can be used in a WLAN system defined according to IEEE 802.11bn and/or a next-generation WLAN system that improves IEEE 802.11bn.

The PPDU of FIG. 6 can be related to various PPDU types used in a UHR system. For example, the example of FIG. 6 can be used for at least one of single-user (SU) mode/type/transmission, multi-user (MU) mode/type/transmission, and null-data packet (NDP) mode/type/transmission related to channel sounding. For example, if the example of FIG. 6 is related to NDP, the data field illustrated can be omitted. If the PPDU of FIG. 6 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 6.

In FIG. 6, L-STF or UHR-LTF may be called a preamble or a physical preamble, and may be generated/transmitted/received/acquired/decoded in the physical layer (included in the transmitting/receiving STA).

Each block illustrated in FIG. 6 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 6.

A subcarrier spacing of the L-STF, L-LTF, L-SIG, RL-SIG, U-SIG, and UHR-SIG fields of FIG. 6 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 kHz.

In the PPDU of FIG. 6, the L-LTF and the L-STF may be the same as those in the conventional fields (for example, non-HT LTF and non-HT STF defined in conventional WLAN standards).

The L-SIG field of FIG. 6 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3.

For example, the (non-AP and AP) STA may apply BCC encoding based on a ½ coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier{subcarrier index −21, −7, +7, +21} and a DC subcarrier{subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index{−28, −27, +27, +28}. The aforementioned signal may be used for channel estimation in the frequency domain corresponding to {−28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index+28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (CBF), spatial reuse (SR), type related to coordinated OFDMA (C-OFDMA), type related to coordinated TDMA (CTDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to modulation and coding scheme (MCS) applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 6. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 6 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 6 may be determined based on RUs (resource units) defined by multiple subcarriers/tones. That is, UHR-LTF, UHR-STF, and data fields of the present disclosure may be transmitted/received through RUs (resource units) defined by multiple subcarriers/tones.

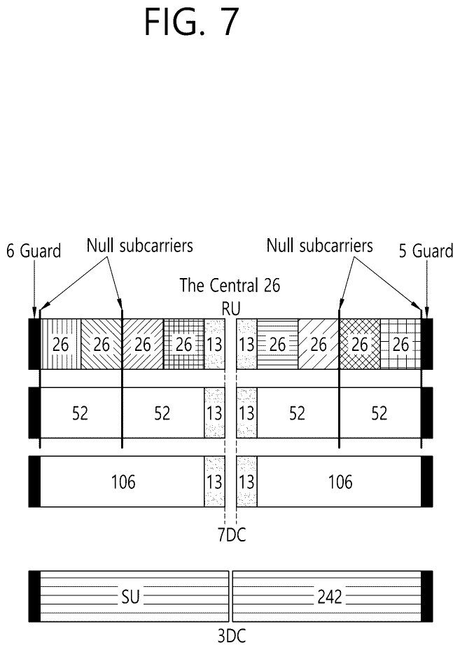

FIG. 7 illustrates the layout of resource units (RUs) used for a 20 MHz PPDU. That is, the UHR-LTF, UHR-STF, and/or data fields included in the 20 MHz PPDU can be transmitted/received through at least one of the various RUs defined in FIG. 7.

As illustrated in the uppermost part of FIG. 7, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the RUs in FIG. 7 may be used not only for a multiple users (MUs) but also for a single user (SU), in which case one 242-unit may be used and three DC tones may be inserted as illustrated in the lowermost part of FIG. 7.

Although FIG. 7 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones). In the present disclosure, N-RU may be represented as N-tone RU, etc. For example, 26-RU may be represented as 26-tone RU.

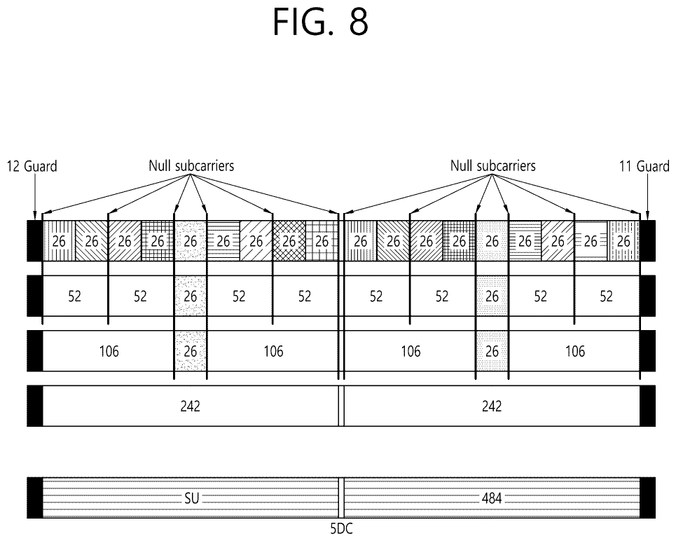

FIG. 8 illustrates the layout of resource units (RUs) used for 40 MHz PPDU.

Similarly to FIG. 7 in which RUs having various sizes are used, a 26-RU, a 52-RU, a 106-RU, a 242-RU, a 484-RU, and the like may be used in an example of FIG. 8. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 8, when the layout of the RUs is used for a single user, a 484-RU may be used. The specific number of RUs may be changed similarly to FIG. 7.

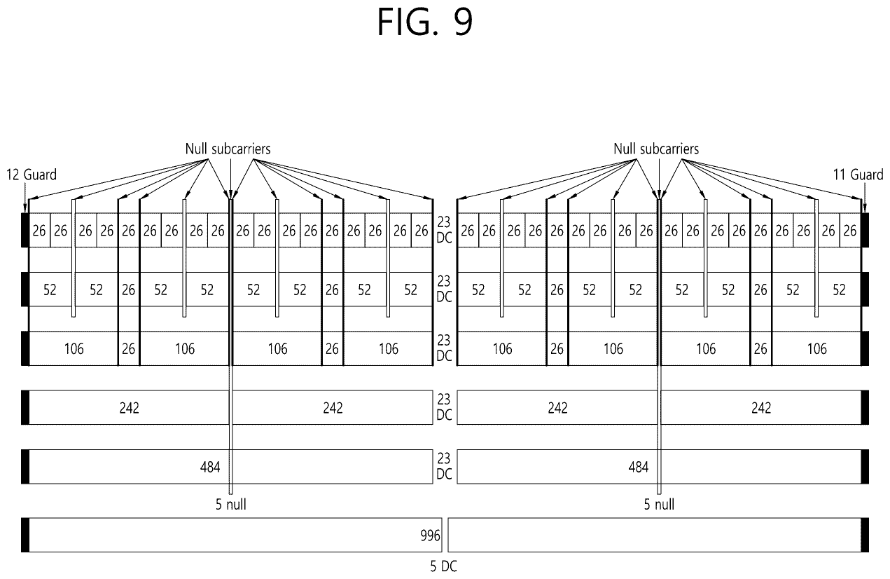

FIG. 9 illustrates the layout of resource units (RUs) used for an 80 MHz PPDU. The layout of the resource units (RUs) used in the present disclosure may vary. For example, the layout of the resource units (RUs) used in the 80 MHz band may vary.

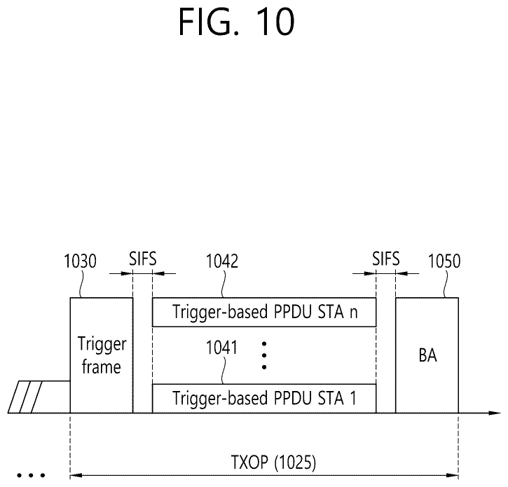

FIG. 10 shows an operation related to UL-MU. As shown, a transmitting STA (e.g., AP) can obtain TXOP 1025 by performing channel access through contending (i.e., backoff operation) and transmit trigger frame 1030. That is, the transmitting STA (e.g., AP) can transmit PPDU including trigger frame 1030. When PPDU including trigger frame is received, trigger-based (TB) PPDU is transmitted after delay of SIFS.

TB PPDU 1041, 1042 can be transmitted at the same time and transmitted from multiple STA (e.g., user STA) whose AID is indicated in trigger frame 1030. ACK frame 1050 for TB PPDU can be implemented in various forms. For example, ACK frame 1050 for TB PPDU can be implemented in the form of block ACK (BA).

In FIG. 10, transmission(s) of trigger Frame 1030, TB PPDU 1041, 1042 and/or ACK Frame 1050 can be performed within TXOP 1025.

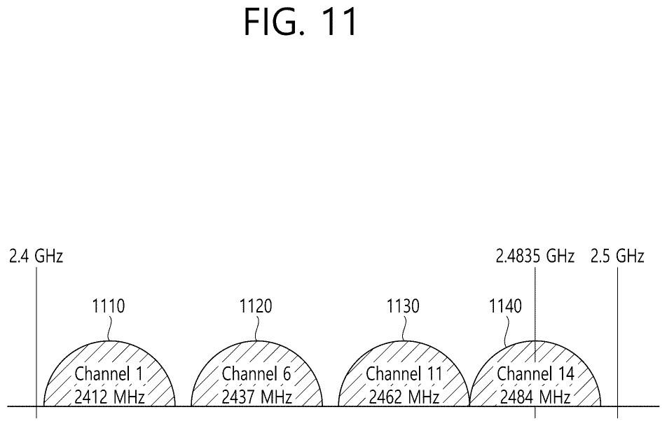

FIG. 11 illustrates an example of channels used/supported/defined within the 2.4 GHz band.

The 2.4 GHz band may also be referred to by other names, such as “first band.” Furthermore, the 2.4 GHz band may refer to a frequency range in which channels with a center frequency adjacent to 2.4 GHz (e.g., channels with a center frequency between 2.4 and 2.5 GHz) are used/supported/defined.

The 2.4 GHz band may include multiple 20 MHz channels. Each 20 MHz within the 2.4 GHz band may have multiple channel indices (e.g., indices 1 through 14). For example, the center frequency of a 20 MHz channel assigned with channel index 1 may be 2.412 GHz, the center frequency of a 20 MHz channel assigned with channel index 2 may be 2.417 GHz, and the center frequency of a 20 MHz channel assigned with channel index N may be (2.407+0.005*N) GHz. Channel indices may be referred to by various names, such as channel numbers. The specific numerical values of the channel indices and center frequencies may vary.

FIG. 11 illustrates examples of four channels within the 2.4 GHz band. The illustrated first frequency region 1110 to fourth frequency regions 1140 may each include one channel. For example, the first frequency region 1110 may include channel 1 (a 20 MHz channel with index 1). In this case, the center frequency of channel 1 may be set to 2412 MHz. The second frequency range 1120 may include channel 6. The center frequency of channel 6 may be set to 2437 MHz. The third frequency range 1130 may include channel 11. The center frequency of channel 11 may be set to 2462 MHz. The fourth frequency range 1140 may include channel 14. The center frequency of channel 14 may be set to 2484 MHz.

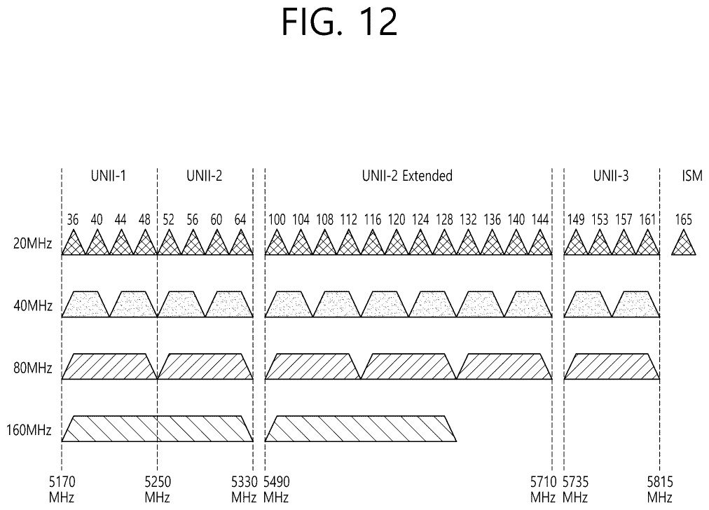

FIG. 12 illustrates an example of channels used/supported/defined within the 5 GHz band.

The 5 GHz band may be referred to by other names, such as “second band” or “band.” The 5 GHz band may refer to a frequency range in which channels with a center frequency of 5 GHz or more but less than 6 GHz (or less than 5.9 GHz) are used/supported/defined. Alternatively, the 5 GHz band may include multiple channels between 4.5 GHz and 5.5 GHz. The specific numerical values shown in FIG. 12 may vary.

The multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2Extended. UNII-3 may be referred to as UNII-Upper.

Multiple channels may be configured within the 5 GHz band, and the bandwidth of each channel may vary, such as 20 MHz, 40 MHz, 80 MHz, or 160 MHz. For example, the 5170 MHz to 5330 MHz frequency range within UNII-1 and UNII-2 may be divided into eight 20 MHz channels. The 5170 MHz to 5330 MHz frequency range can be divided into four channels across a 40 MHz frequency band. The 5170 MHz to 5330 MHz frequency range can be divided into two channels across an 80 MHz frequency band. Alternatively, the 5170 MHz to 5330 MHz frequency range can be divided into one channel across a 160 MHz frequency band.

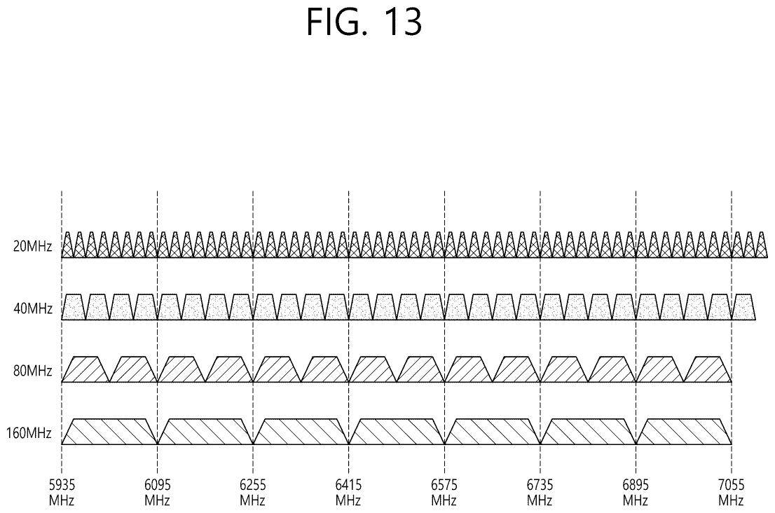

FIG. 13 illustrates an example of channels used, supported, and defined within the 6 GHz band.

The 6 GHz band may also be referred to by other names, such as the third band. The 6 GHz band may refer to a frequency range in which channels with center frequencies above 5.9 GHz are used, supported, and defined. The specific numbers shown in FIG. 13 may vary.

For example, the 20 MHz channel in FIG. 13 may be defined starting from 5.940 GHz. Specifically, the leftmost channel among the 20 MHz channels in FIG. 13 may have an index of 1 (or channel index, channel number, etc.), and a center frequency of 5.945 GHz may be assigned. That is, the center frequency of the index N channel may be determined as (5.940+0.005*N) GHz.

Accordingly, the indexes (or channel numbers) of the 20 MHz channels of FIG. 13 are 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, It can be 197, 201, 205, 209, 213, 217, 221, 225, 229, 233. Also, according to the (5.940+0.005*N) GHz rule mentioned above, the indices of the 40 MHz channels in FIG. 13 can be 3, 11, 19, 27, 35, 43, 51, 59, 67, 75, 83, 91, 99, 107, 115, 123, 131, 139, 147, 155, 163, 171, 179, 187, 195, 203, 211, 219, 227.

The structure and types/subtypes of MAC frames are described below.

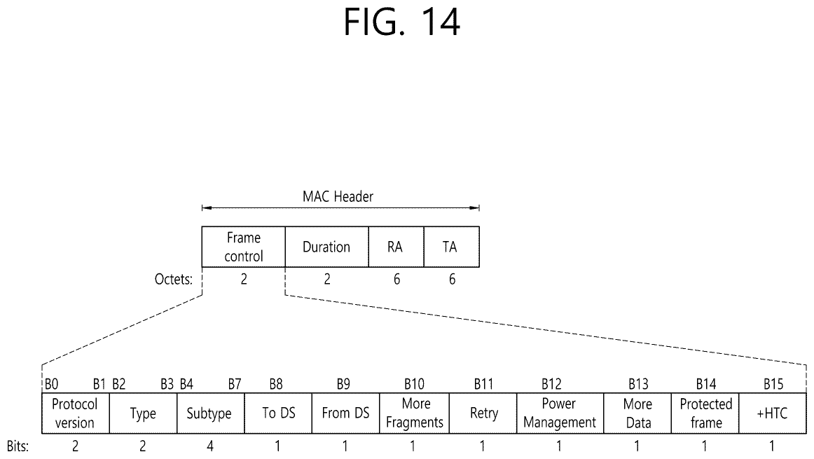

FIG. 14 shows an example of a MAC frame header. As shown, a MAC frame may include a 2-octet frame control field/information, a 2-octet duration field/information, a 6-octet receiver address (RA) field/information, and a 6-octet transmitter address (TA) field/information. As shown in FIG. 14, the four fields may be contiguous. The MAC header of FIG. 14 may be modified in various ways, with new fields inserted between the four fields shown, or at least one of the fields shown may be omitted.

The MAC header shown in FIG. 14 may be positioned at the very beginning of the MAC frame. That is, the MAC frame may include a MAC header as shown in FIG. 14 and a MAC body field/information may be contiguous to the MAC header. A MAC frame including the MAC header of FIG. 14 is inserted/included in the data field of a PPDU (e.g., a UHR PPDU) shown in FIG. 6.

The MAC frames included in the data field of the PPDU of the present disclosure can be classified into various types. For example, the MAC frames of the present disclosure can be classified into control frames, management frames, and data frames.

For example, the management frame includes Association Request, Association Response, Reassociation Request, Reassociation Response, Probe Request, Probe Response, Beacon, Disassociation, Authentication, and Deauthentication frames/signals defined in conventional WLANs. For the management frame, the value of the type field (B3 and B2) in FIG. 14 is set to 00. Additionally, the values of the subtype fields (B7, B6, B5, B4) in FIG. 14 are as follows: Association Request (0000), Association Response (0001), Reassociation Request (0010), Reassociation Response (0011), Probe Request (0100), Probe Response (0101), Beacon (1000), Disassociation (1010), Authentication (1011), Deauthentication (1100).

For example, the control frame includes the Trigger Beamforming Report Poll, NDP Announcement (NDPA), Control Frame Extension, Control Wrapper, Block Ack Request (BlockAckReq), Block Ack (BlockAck), PS-Poll, RTS, CTS, Ack, and CF-End frames/signals defined in conventional WLANs. For the control frame, the values of the type fields (B3 and B2) in FIG. 14 are set to 01. Additionally, the values of the subtype fields (B7, B6, B5, B4) in FIG. 14 are as follows: Trigger (0010), Beamforming Report Poll (0100), NDP Announcement (0101), Control Frame Extension (0110), Control Wrapper (0111), BlockAckReq (1000), BlockAck (1001), PS-Poll (1010), RTS (1011), CTS (1100), Ack (1101), CF-End (1110).

For example, the data frame includes (QoS) Data, (QoS) Null, etc., as defined in conventional WLANs. For this data frame, the values of the type fields (B3 and B2) in FIG. 14 are set to 10.

Meanwhile, non-AP MLDs/STAs can roam between AP MLDs. MLD and roaming are described below.

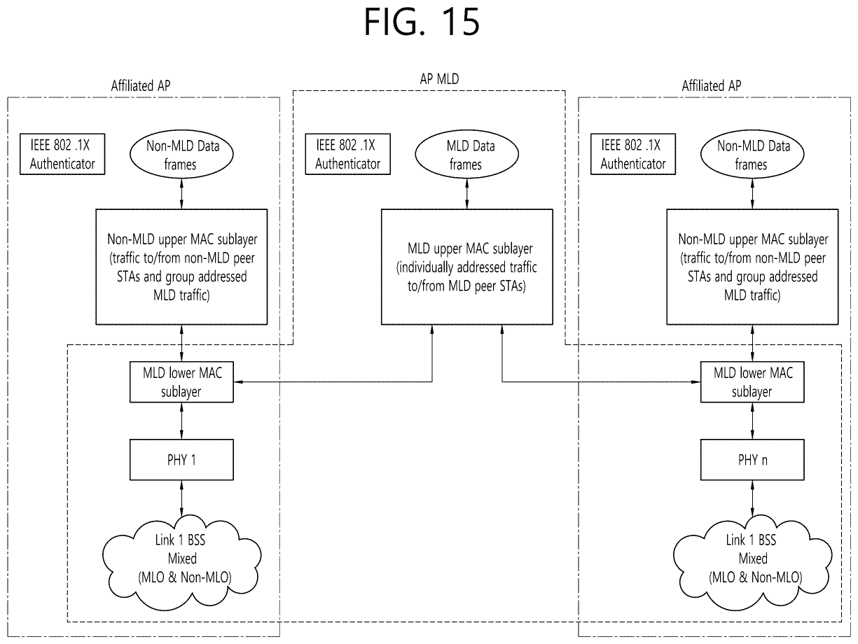

FIG. 15 shows the high-level architecture of the AP MILD.

Referring to FIG. 15, an AP MLD can include at least one AP. The MLD can control various procedures/parameters common to multiple APs using the upper MAC layer/sublayer. For example, the MLD can perform/control authentication, association, sequence number (SN)/packet number (PN) allocation, and power-saving buffering of individually addressed frames.

Therefore, when the AP MLD function is used, MLD-level parameters can be maintained without being reset when a non-AP MLD/STA moves/roams between APs affiliated with the AP MLD.

In the present disclosure, a non-AP MLD/STA can roam from a serving/source AP MLD to another AP MLD (i.e., a target AP MILD). Alternatively, a non-AP MLD/STA can roam from at least one AP in the serving/source AP MLD to at least one AP in another AP MLD (i.e., a target AP MLD). At this time, the non-AP MLD/STA can maintain an associated state and authenticated state during and after roaming to another AP MILD. Roaming may include establishing a link with at least one AP of the target AP MLD and/or releasing a link with at least one AP of the serving/source AP MLD. For example, the non-AP MLD/STA may release a link with at least one AP of the serving/source AP MLD after establishing a link with at least one AP of the target AP MLD. As another example, the non-AP MLD/STA may release a link with at least one AP of the serving/source AP MLD and then establish a link with at least one AP of the target AP MLD.

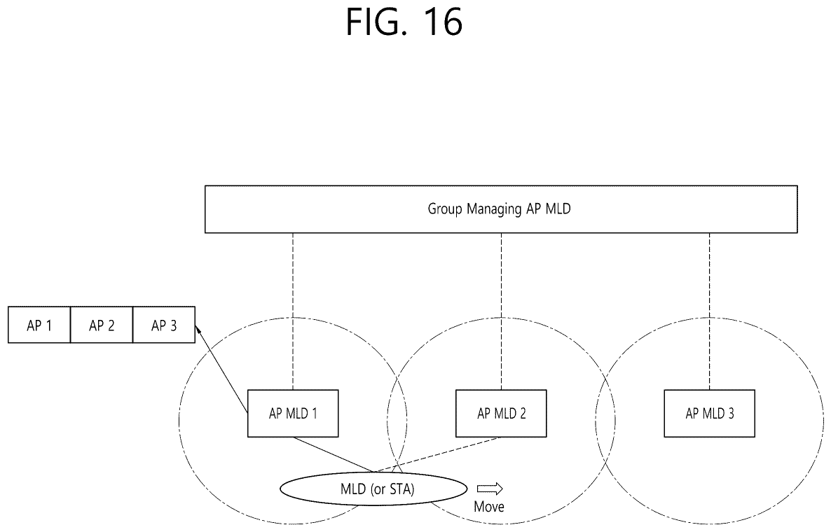

The deployment of AP MLDs for roaming is shown in FIG. 16.

FIG. 16 shows the deployment of AP MLDs for roaming.

Referring to FIG. 16, each AP MLD is located in a different location, i.e., non-collocated, while the APs belonging to/affiliated with each AP MLD are located in the same or similar locations, i.e., collocated. Collocated APs may mean they belong to the same physical device, or they may be logically located in similar locations, even if they are not on the same physical device. Basically, since an AP MLD is a logical entity, it can be any single physical device, but it can function as an MLD that covers affiliated APs regardless of location and can apply MLO. Ultimately, all APs belonging to each AP MLD can be affiliated with a group-managing AP MILD. For example, AP MLD 1 in FIG. 16 may include affiliated APs 1, AP2, and AP3.

In the present disclosure, AP MLDs including APs affiliated with a group-managing AP MLD can be included in a roaming group, and roaming can be performed between the AP MLDs/APs included in the roaming group. In other words, roaming between AP MLDs included in a roaming group is possible, but roaming between an AP MLD included in a roaming group and an AP MLD not included in the roaming group may not be possible. AP MLDs included in a roaming group may be referred to as group member AP MLDs. For example, in FIG. 16, AP MLD 1, AP MLD 2, and AP MLD 3 may be group member AP MLDs.

When a non-AP MLD/STA moves, it can roam from one AP MLD to another. However, roaming is not limited to a mobility between different AP MLDs. For example, a non-AP MLD/STA can change APs by roaming within an AP MLD.

Meanwhile, a moving non-AP MLD/STA must be able to identify which AP to roam to within the Group-managing AP MLD with which the non-AP MLD/STA is associated, and when roaming is requested, the Group-managing MLD should be able to determine whether the previous AP needs to forward data or management information to the new AP, depending on which new AP the non-AP MLD/STA moves to from the previous AP. Therefore, an identification/identifier (ID) for the roaming group and/or the roaming-managing AP MLD may be required. The present disclosure proposes an identification method that considers non-collocated APs affiliated with a Group-managing AP MLD.

The references (names) in this disclosure may be changed, and STA may include AP STA and/or non-AP STA.

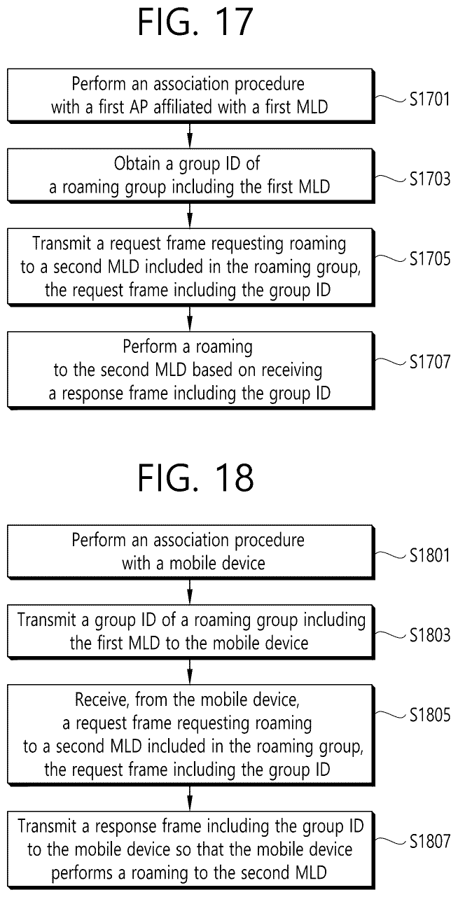

FIG. 17 shows an example of a method performed by a mobile device for identification related to roaming according to an embodiment of the present disclosure. The mobile device may be an MLD comprising at least one STA.

Referring to FIG. 17, in step S1701, the mobile device may perform an association procedure with a first AP affiliated with a first MLD.

In step S1703, the mobile device may obtain a group ID of a roaming group including the first MLD.

In step S1705, the mobile device may transmit a request frame requesting roaming to a second MLD included in the roaming group. The request frame may include the group ID.

In step S1707, the mobile device may perform a roaming to the second MLD based on receiving a response frame including the group ID.

In various embodiments, the performing of the roaming to the second MLD may comprise: establishing a link with a second AP affiliated with the second MLD; and releasing a link with a first AP affiliated with the first MLD.

In various embodiments, during a process of the roaming to the second MLD, the link with the first AP may be released after the link with the second AP is established. Alternatively, the link with the first AP may be established after the link with the second AP is released.

In various embodiments, the mobile device may maintain an associated state during and after the roaming is performed.

In various embodiments, the roaming group may include MLDs between which roaming can be performed.

In various embodiments, the group ID may be obtained by receiving a management frame including at least one of a reduced neighbor report (RNR) element or a Basic Multi-Link element. The group ID may be included in at least one of the RNR element or the Basic Multi-Link element.

In various embodiments, the request frame may be a probe request frame including a probe request multi-link element. The group ID may be included in at least one of a Common information (Info) field or a Link Info field in the probe request multi-link element.

In various embodiments, the response frame may be a probe response frame including a Basic Multi-link element. The group ID may be included in at least one of a Common Info field or a Link Info field in the Basic Multi-link element.

In various embodiments, at least one of the Common Info field or the Link Info field may further include a subfield indicating whether the group ID is present.

In various embodiments, the mobile device may obtain an ID of the second MLD. The group ID and the ID of the second MLD may be obtained by receiving a management frame including at least one of a reduced neighbor report (RNR) element or a Basic Multi-link element. The group ID and the ID of the second MLD may be included in at least one of the RNR element or the Basic Multi-link element.

In various embodiments, the request frame may be a probe request frame including a probe request multi-link element. The group ID and an ID of the second MLD may be included in at least one of a Common Info field or a Link Info field in the probe request multi-link element.

In various embodiments, the response frame may be a probe response frame including a Basic Multi-link element. The group ID and an ID of the second MLD may be included in at least one of a Common Info field or a Link Info field in the Basic Multi-link element.

In various embodiments, the group ID may be included in the Common Info field, and the ID of the second MLD is included in the Link Info field.

In various embodiments, at least one of the Common Info field or the Link Info field may include a subfield indicating whether the group ID is present, and a subfield indicating whether the ID of the second MILD is present.

In various embodiments, the subfield indicating whether the group ID is present may be included in the Common Info field, and the subfield indicating whether the ID of the second MLD is present may be included in the Link Info field.

FIG. 18 shows an example of a method performed by an AP for identification related to roaming according to an embodiment of the present disclosure. The AP may be affiliated with a first MLD.

Referring to FIG. 18, in step S1801, the AP may perform an association procedure with a mobile device.

In step S1803, the AP may transmit a group ID of a roaming group including the first MLD to the mobile device.

In step S1805, the AP may receive, from the mobile device, a request frame requesting roaming to a second MLD included in the roaming group. The request frame may include the group ID.

In step S1807, the AP may transmit a response frame including the group ID to the mobile device so that the mobile device performs a roaming to the second MLD.

Hereinafter, a specific implementation for identification related to roaming is described.

### I. Group ID Configuration for Roaming

(1) ID Configuration for Roaming within the Group-Managing AP MLD

In some implementations, IDs may be assigned to collocated Group-member AP MLDs. In the present disclosure, a newly defined Group-member AP MLD ID may be used for the Group-member AP MLD. In another example, an existing AP MLD ID may be used for the Group-member AP MLD. This Group-member AP MLD ID may be unique within a Group-member AP MLD, or a unique ID may be assigned to the Group-member AP MLD within the entire Group-managing AP MLD or a roaming group. The ID may be assigned to the Group-managing AP MLD that affiliates the Group-member AP MLDs (i.e., the Group-managing AP MLD that affiliates the APs affiliated with the Group-member AP MLDs). In the present disclosure, the ID assigned to a Group-managing AP MLD that affiliates Group-member AP MLDs may be referred to as a Group-managing AP MLD ID or roaming group ID (or group ID). This Group-managing AP MLD ID may be unique within the Group-managing AP MLD or may be unique within the entire network. By defining a Group-managing AP MLD ID to distinguish Group-managing AP MLDs, scalability issues caused by a limited number of links can be resolved and identification of more APs can be enabled.

(2) Unique ID Configuration within a Group-Member AP MLD within a Group-Managing AP MLD

In some implementations, a Group-member AP MLD ID may be unique within a Group-member AP MLD. The Group-member AP MLD ID may have a value such as 0, 1, 2, etc. For example, if the bit size of the Group-member AP MLD ID is 4 bits, the Group-member AP MLD ID can have a value from 0 to 15. If the bit size of the Group-member AP MLD ID is 8 bits, the Group-member AP MLD ID can have a value from 0 to 127 (or 0 to 255). This is an example, and the bit size of the Group-member AP MLD ID can be varied.

For example, when the Group-member AP MLD ID is 0, the APs having the Group-member AP MLD ID of 0 may be considered to be collocated and/or affiliated with the same Group-member AP MLD. That is, if a non-AP MLD/STA identifies a Group-member AP MLD ID, it can identify APs affiliated with the corresponding Group-member AP MLD as collocated. Additionally, since other APs belonging to the multiple BSSID sets to which each AP affiliated with the Group-member AP MLD belongs (e.g., transmitted BSSID (TxBSSID) or nontransmitted BSSID (NonTxBSSID)) also use the same physical resources, the Group-member AP MLD ID may also be assigned to these APs. However, other APs in the multi-BSSID set to which these APs belong (e.g., transmitted BSSID (TxBSSID) or nontransmitted BSSID (NonTxBSSID)) may have different AP MLD IDs (i.e., may be affiliated with different AP MLDs).

For example, different Group-member AP MLD IDs (e.g., Group-member AP MLD IDs with non-zero value) may be mapped to each Group-member AP MLD so that each Group-member AP MLD can be uniquely identified.

(3) Unique ID Configuration within the Group-Managing AP MLD in the Network

In some implementations, the Group-managing AP MLD ID (or group ID) may be unique within a network. The Group-managing AP MLD ID can have values such as 0, 1, 2, etc. For example, if the bit size of the Group-managing AP MLD ID is 4 bits, the Group-managing AP MLD ID can have values from 0 to 15, and if the bit size of the Group-managing AP MLD ID is 8 bits, the Group-managing AP MLD ID can have values from 0 to 127 (or values from 0 to 255). The bit size of the Group-managing AP MLD ID can be varied.

For example, if the Group-managing AP MLD ID (or group ID) is 0, the APs having the Group-managing AP MLD ID 0 can be considered as APs affiliated with the same Group-managing AP MLD (i.e., APs affiliated with Group-member AP MLDs included in the roaming group of the same Group-managing AP MILD). That is, when a non-AP MLD/STA identifies the Group-managing AP MLD ID/group ID, the APs can identify that they are currently affiliated with the same Group-managing AP MLD (or affiliated with Group-member AP MHLDs included in the same group). In addition, since other APs in the multi-BSSID set to which each AP affiliated with this Group-managing AP MLD belongs (e.g., transmitted BSSID (TxBSSID) or nontransmitted BSSID (NonTxBSSID)) also use the same physical resources, the Group-managing AP MLD ID can also be assigned to these APs. However, the AP MLD IDs of the transmitted BSSID (TxBSSID) or nontransmitted BSSID (NonTxBSSID) AP MLDs to which these APs belong may be different.

For example, different Group-managing AP MLD IDs (e.g., a Group-managing AP MLD ID with a non-zero value) may be mapped so that each Group-managing AP MLD can be uniquely identified.

(4) Unique ID Configuration within a Group-Managing AP MLD

In some implementations, a Group-member AP MLD ID may be uniquely assigned to a Group-member AP MLD within the entire Group-managing AP MLD, and/or a Group-managing AP MLD ID may be uniquely assigned to a Group-managing AP MLD within the entire network.

The Group-member AP MLD ID may have a value of 0, 1, 2, etc. For example, if the bit size of the Group-member AP MLD ID is 4 bits, the Group-member AP MLD ID can have a value from 0 to 15. If the bit size of the Group-member AP MLD ID is 8 bits, the Group-member AP MLD ID can have a value from 0 to 127 (or 0 to 255). The bit size of the Group-member AP MLD ID can be changed.

The Group-managing AP MLD ID can have a value from 0, 1, 2, etc. For example, if the bit size of the Group-managing AP MLD ID is 4 bits, the Group-managing AP MLD ID can have a value from 0 to 15. If the bit size of the Group-managing AP MLD ID is 8 bits, the Group-managing AP MLD ID can have a value from 0 to 127 (or 0 to 255). The bit size of the Group-managing AP MLD ID can be changed.

### II. Group ID Announcement

In some implementations, when a newly defined Group-member AP MLD ID is used for a Group-member AP MLD, each AP in each AP MLD may announce MLD roaming information (or roaming information) that includes information indicating whether roaming is enabled, a Group-managing AP MLD ID, and/or a Group-member AP MLD ID. For example, the MLD roaming information announced by each AP in each AP MLD may include at least one of the followings:

MLD roaming enabled: An indication of whether roaming is enabled. This information may be a 1-bit indication.

Group-managing AP MLD ID (or roaming group ID): The ID of the Group-managing AP MLD or the roaming group ID in the network. That is, APs associated with the ID may be affiliated with the same Group-managing AP MLD.

Group-member AP MLD ID: The ID of the Group-member AP MLD belonging to the Group-managing AP MLD. That is, APs associated with the corresponding ID can be affiliated with the same Group-member AP MLD.

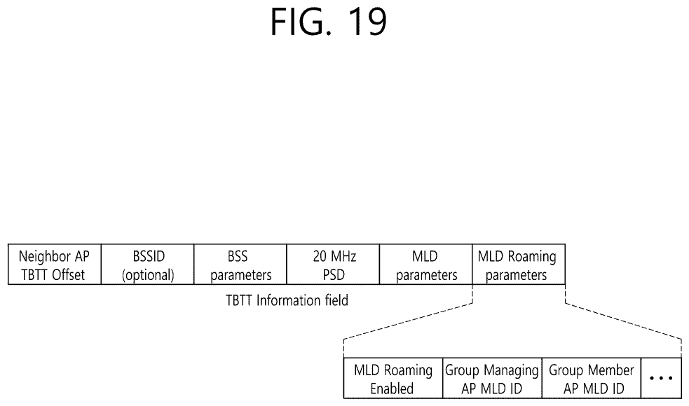

The above-described MLD roaming information can be included in a management (MGMT) frame (e.g., a beacon frame or a probe response frame). For example, the MLD roaming information can be included in the MLD roaming information element (IE) of the beacon frame/probe response frame, or in the reduced neighbor report (RNR) IE of the beacon frame/probe response frame. When the MLD roaming information is included in the RNR IE, the format of the RNR IE is as shown in FIG. 19.

FIG. 19 shows a first example of the format of an RNR IE including MLD roaming information according to an embodiment of the present disclosure.

Referring to FIG. 19, MLD roaming information may be included in a target beacon transmission time (TBTT) information field of the RNR IE for each AP. For example, the MLD roaming information may be included in the MLD parameters subfield of the TBTT information field. If the size of the MLD parameter subfield is not sufficient, the size of the MLD parameter subfield may be modified to include MLD roaming information.

However, since modifying the size of the MLD parameters subfield may cause decoding issues for STAs, if the size of the MLD parameter subfield is not sufficient enough, a new MLD roaming parameters subfield may be defined in the TBTT information field to include the MLD roaming information. As shown in FIG. 19, the MLD roaming parameter subfield may include an MLD roaming enabled subfield, a Group-managing AP MLD ID, and a Group-member AP MLD ID. In this case, the MLD roaming parameter subfield may not include an MLD roaming enabled subfield, as the presence of the MLD roaming parameter subfield itself may indicate that MLD roaming is enabled.

Since the MLD roaming information may be MLD-related information, the MLD roaming information may be included in the Basic Multi-link IE of the beacon frame/probe response frame.

In some implementations, when the existing AP MLD ID is used for the Group-member AP MLD, each AP in each AP MLD may announce MLD roaming information (or roaming information) that includes information indicating whether roaming is enabled, the Group-managing AP MLD ID, and/or the Group-member AP MLD ID. For example, the MLD roaming information announced by each AP in each AP MLD may include at least one of the followings:

MLD roaming enabled: An indication of whether roaming is enabled. This information may be a 1-bit indication.

Group-managing AP MLD ID (or roaming group ID): The ID of the Group-managing AP MLD or the roaming group ID in the network. That is, APs associated with the ID may be affiliated with the same Group-managing AP MLD.

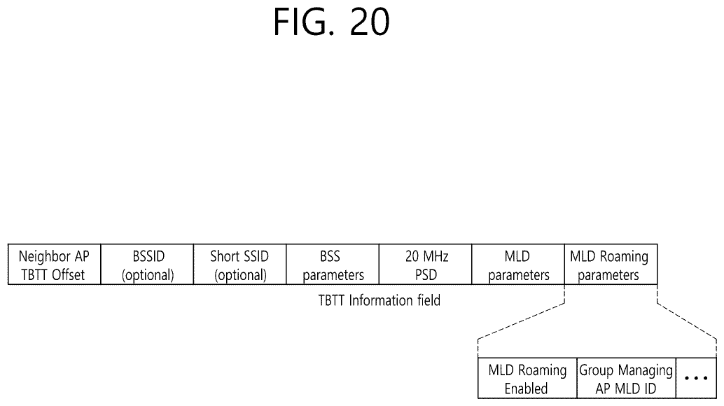

The above-described MLD roaming information may be included in a management (MGMT) frame (e.g., a beacon frame or probe response frame). For example, the MLD roaming information may be included in the MLD roaming information element (IE) of the beacon frame/probe response frame, or in the reduced neighbor report (RNR) IE of the beacon frame/probe response frame. When the MLD roaming information is included in the RNR IE, the format of the RNR IE is as shown in FIG. 20.

FIG. 20 shows a second example of the format of an RNR IE including MLD roaming information, according to an embodiment of the present disclosure.

Referring to FIG. 20, MLD roaming information may be included in the target beacon transmission time (TBTT) information field of the RNR IE for each AP. For example, the MLD roaming information may be included in the MLD parameters subfield of the TBTT information field. If the size of the MLD parameters subfield is not sufficient, the size of the MLD parameters subfield may be modified to include the MLD roaming information.

However, since modifying the size of the MLD parameters subfield may cause decoding issues for STAs, if the size of the MLD parameters subfield is not sufficient, a new MLD roaming parameters subfield may be defined in the TBTT information field to include the MLD roaming information. As shown in FIG. 20, the MLD Roaming Parameters subfield may include an MLD Roaming Enabled subfield and a Group-managing AP MLD ID. In this case, the presence of the MLD Roaming Parameters subfield itself may indicate MLD roaming is enabled, so the MLD Roaming Parameters subfield may not include the MLD Roaming Enabled subfield.

Since MLD roaming information may be MLD-related, it may be included in the Basic Multi-link IE of the beacon frame/probe response frame.

### III. Group ID Request/Response

Before roaming, a non-AP MLD/STA may request information about the APs within each Group-member AP MLD (or the APs affiliated with each Group-member AP MLD) for roaming between AP MLDs. To request information about the APs affiliated with each Group-member AP MLD, the multi-link probe request/response, which is utilized to obtain information for MLO, may be used.

In the present disclosure, a multi-link probe request refers to a probe request frame transmitted by an STA affiliated with a non-AP MLD, which carries a probe request multi-link element to request information about one or more APs affiliated with the AP MLD.

The probe request multi-link element may include a multi-link control field, a common info field, and/or a link info field. The multi-link control field may include a Present bitmap subfield. The link info field may include Per-STA Profile subelements. The Per-STA Profile subelement may have a format as shown in <table 1> below:

TABLE 1

| | | | | |
|---|---|---|---|---|
| Subelement ID | Length | STA Control | STA Info | STA Profile |

In <Table 1>, the STA Info field may be omitted. In this case, the STA Control field may be adjacent to the STA Profile field, and the STA Profile field may be placed immediately after the STA Control field (or, the STA Control field may be placed immediately before the STA Profile field). In some implementations, if a newly defined Group-member AP MLD ID is used for the Group-member AP MLD, the Group-managing AP MLD ID and Group-member AP MLD ID may be included in the Common Info field and/or the Link Info field of the probe request multi-link element, as follows:

### A-1) Included in the Common Info Field

The Present bitmap subfield may indicate whether the Common Info field includes the Group-managing AP MLD ID and/or the Group-member AP MLD ID. For example, the Present bitmap subfield may have a format as shown in <Table 2> below:

TABLE 2

| | | | |
|---|---|---|---|
| AP MLD ID | Group-managing AP | Group-member AP | Reserved |
| present | MLD ID present | MLD ID present | |

In <Table 2>, the Group-managing AP MLD ID Present field can indicate whether the Common Info field includes the Group-managing AP MLD ID. The Group-member AP MLD ID Present field can indicate whether the Common Info field includes the Group-member AP MLD ID. When the Group-managing AP MLD ID and the Group-member AP MLD ID are included in the Common Info field, the Common Info field can have a format as shown in <Table 3> below:

TABLE 3

| | | | |
|---|---|---|---|
| Common Info | AP MLD ID | Group-managing AP | Group-member AP |
| Length | | MLD ID | MLD ID |

If the Group-managing AP MLD ID and Group-member AP MLD ID are included in the Common Info field, the multi-link probe request can only request information of APs affiliated with the same Group-managing AP MLD ID and Group-member AP MLD ID. In other words, information of APs affiliated with the same Group-managing AP MLD but with different Group-member AP MLD IDs may not be requested.

### A-2) Included in the Link Info Field—Always Present

The Group-managing AP MLD ID and Group-member AP MLD ID may always be present in the Link Info field. In this case, the Link Info field may not include the Group-managing AP MLD ID Present field and the Group-member AP MLD ID Present field.

The Link Info field may include multiple Per-STA Profile subelements, and the format of each Per-STA Profile subelement is as shown in <Table 1> above. The Group-managing AP MLD ID and Group-member AP MLD ID may be included in the STA Control field of the Per-STA Profile subelement, as shown in <Table 4> below:

TABLE 4

| | | | | |
|---|---|---|---|---|
| Link | Complete Profile | Group-managing | Group-member | Reserved |
| ID | Requested | AP MLD ID | AP MLD ID | |

Each Link ID can indicate a request for a corresponding AP. The Group-member AP MLD ID in the STA Control field of the Per-STA Profile subelement can indicate a Group-member AP MLD. If the Group-managing AP MLD ID and the Group-member AP MLD ID are included in the Link Info field, information about APs affiliated with multiple Group-member AP MLD IDs can be requested. However, when requesting information about APs affiliated with the same Group-member AP MLD, including the Group-managing AP MLD ID and the Group-member AP MLD ID in the Link Info field may incur greater overhead than including them in the Common Info field.

A-3) Inclusion in the Link Info Field—when not Always Present

The Group-managing AP MLD ID and the Group-member AP MLD ID may not always be present in the Link Info field. In this case, the Link Info field may include the Group-managing AP MLD ID Present field and the Group-member AP MLD ID Present field.

For example, the Group-managing AP MLD ID Present field and the Group-member AP MLD ID Present field may be included in the STA Control field of the Per-STA profile subelement. The Group-managing AP MLD ID Present field may indicate whether the Group-managing AP MLD ID for the AP corresponding to the Link ID is included in the Link Info field. The Group-member AP MLD ID Present field may indicate whether the Group-member AP MLD ID for the AP corresponding to the Link ID is included in the Link Info field. In this case, the Group-managing AP MLD ID and/or the Group-member AP MLD ID may be included in the STA Info field or the STA Profile field. When the Group-managing AP MLD ID and the Group-member AP MLD ID are included in the Link Info field, information about APs affiliated with multiple Group-member AP MLD IDs may be requested.

For example, when requesting information about APs affiliated with the same Group-member AP MLD, the Group-member AP MLD ID may be included in the Common Info field and not in the Link Info field. Therefore, this case may reduce overhead compared to cases where the Group-member AP MLD ID is necessarily included in the Link Info field.

For example, if the Common Info field includes the Group-managing AP MLD ID and the Group-member AP MLD ID, this may imply that information for APs corresponding to the same Group-member AP MLD ID is being requested. In this case, the Link Info field may not include the Group-managing AP MLD ID and the Group-member AP MLD ID. Accordingly, the Group-managing AP MLD ID Present field and the Group-member AP MLD ID Present field may not be included in the Link Info field.

In some implementations, if the existing AP MLD ID is used for the Group-member AP MLD, the Group-managing AP MLD ID may be included in the Common Info field and/or the Link Info field of the probe request multi-link element, as follows:

### B-1) Included in the Common Info Field

The Present bitmap subfield may indicate whether the Group-managing AP MLD ID is included in the Common Info field. For example, the Present bitmap subfield may have a format as shown in <Table 5> below:

TABLE 5

| | | |
|---|---|---|
| AP MLD ID present | Group-managing AP | Reserved |
| | MLD ID present | |

In <Table 5>, the Group-managing AP MLD ID Present field can indicate whether the Common Info field includes the Group-managing AP MLD ID. If the Group-managing AP MLD ID is included in the Common Info field, the Common Info field can have a format similar to <Table 6> below:

TABLE 6

| | | |
|---|---|---|
| Common Info Length | AP MLD ID | Group-managing AP |
| | | MLD ID |

If the Group-managing AP MLD ID is included in the Common Info field, the multi-link probe request can only request information of APs affiliated with Group-member AP MLDs with the same Group-managing AP MLD ID and AP MLD ID. In other words, information of APs affiliated with the same Group-managing AP MLD but with different AP MLD IDs may not be requested.

### B-2) Included in the Link Info Field—Always Present

The Group-managing AP MLD ID may always be present in the Link Info field. In this case, the Link Info field may not include the Group-managing AP MLD ID Present field.

The Link Info field may include multiple Per-STA Profile subelements, and the format of each Per-STA Profile subelement is as shown in <Table 1> above. The Group-managing AP MLD ID may be included in the STA Control field of the Per-STA Profile subelement, as shown in <Table 7> below:

TABLE 7

| | | | |
|---|---|---|---|
| Link | Complete Profile | Group-managing | Reserved |
| ID | Requested | AP MLD ID | |

Each Link ID can be used to indicate a request for a corresponding AP. The AP MLD ID included in the probe request multi-link element and the Group-managing AP MLD ID in the STA Control field of the Per-STA Profile subelement can indicate a Group-member AP MLD. If the Group-managing AP MLD ID is included in the Link Info field, information about APs affiliated with multiple AP MLD IDs can be requested. However, when requesting information about APs affiliated with the same Group-member AP MLD, including the Group-managing AP MLD ID in the Link Info field may incur greater overhead than including it in the Common Info field.

B-3) Inclusion in the Link Info Field—Cases where it is not Always Present

The Group-managing AP MLD ID may not always be present in the Link Info field. In this case, the Link Info field may include a Group-managing AP MLD ID Present field.

For example, the Group-managing AP MLD ID Present field may be included in the STA Control field of the Per-STA Profile subelement. The Group-managing AP MLD ID Present field can indicate whether the Group-managing AP MLD ID for the AP corresponding to the Link ID is included in the Link Info field. In this case, the Group-managing AP MLD ID may be included in the STA Info field or the STA Profile field. If the Group-managing AP MLD ID is included in the Link Info field, information about APs affiliated with multiple AP MLD IDs may be requested.

For example, when requesting information about APs affiliated with the same AP MLD ID, the Group-managing AP MLD ID may be included in the Common Info field and not in the Link Info field. Therefore, this case may reduce overhead compared to when the Group-managing AP MLD ID is necessarily included in the Link Info field.

For example, if the Common Info field includes the Group-managing AP MLD ID, this may imply that information about APs corresponding to the same AP MLD ID is being requested. In this case, the Link Info field may not include the Group-managing AP MLD ID. Accordingly, the Group-managing AP MLD ID Present field may also not be included in the Link Info field.

In the present disclosure, a multi-link probe response refers to a probe response frame transmitted by an AP affiliated with an AP MLD, which carries a Basic Multi-Link element in response to a multi-link probe request to provide a complete profile or requested information for one or more APs affiliated with the AP MLD.

The Basic Multi-Link element may include a Multi-Link Control field, a Common Info field, and/or a Link Info field. The Multi-Link Control field may include a Present Bitmap subfield. The Link Info field may include Per-STA Profile subelements. The Per-STA Profile subelement may have a format as shown in Table 8 below.

TABLE 8

| | | | | |
|---|---|---|---|---|
| Subelement ID | Length | STA Control | STA Info | STA Profile |

In <Table 8>, the STA Info field may be omitted. In this case, the STA Control field may be adjacent to the STA Profile field, and the STA Profile field may be placed immediately after the STA Control field (or, the STA Control field may be placed immediately before the STA Profile field). In some implementations, if a newly defined Group-member AP MLD ID is used for the Group-member AP MLD, the Group-managing AP MLD ID and Group-member AP MLD ID may be included in the Common Info field and/or the Link Info field of the Basic Multi-link element, as follows:

### C-1) Included in the Common Info Field

This method may be applied when a multi-link probe request including the Group-managing AP MLD ID and Group-member AP MLD ID is transmitted according to the method described in “A-1) Included in the Common Info field” above.

According to this method, the Present bitmap subfield of the Basic Multi-link element may include the Group-managing AP MLD ID Present field and the Group-member AP MLD ID Present field. The Group-managing AP MLD ID Present field can indicate whether the Group-managing AP MLD ID is included in the Common Info field. The Group-member AP MLD ID Present field can indicate whether the Group-member AP MLD ID is included in the Common Info field. Accordingly, the Group-managing AP MLD ID and Group-member AP MLD ID can be included in the Common Info field. If the Group-managing AP MLD ID and Group-member AP MLD ID are included in the Common Info field, the corresponding multi-link probe response can only provide information about APs affiliated with the same Group-member AP MLD.

### C-2) Included in the Link Info Field—Always Present

This method can be applied when a multi-link probe request containing the Group-managing AP MLD ID and Group-member AP MLD ID is transmitted according to the “A-2) Included in the Link Info Field—Always Present” method above.

According to this method, the Group-managing AP MLD ID and Group-member AP MLD ID for the AP corresponding to the link ID of each Per-STA Profile subelement can be included in the STA Control field of the corresponding Per-STA Profile subelement. When the Group-managing AP MLD ID and Group-member AP MLD ID are included in the Link Info field, information about APs affiliated with multiple Group-member AP MLD IDs can be provided. However, when information about APs affiliated with the same Group-member AP MLD is provided, including the Group-managing AP MLD ID and Group-member AP MLD ID in the Link Info field may incur greater overhead than including them in the Common Info field.

### C-3) Inclusion in the Link Info Field—not Always Present

This method can be applied when multiple Link Probe Requests containing the Group-managing AP MLD ID and Group-member AP MLD ID are transmitted according to the method described above, “A-3) Inclusion in the Link Info Field—Not Always Present.”

According to this method, the Group-managing AP MLD ID Present field and the Group-member AP MLD ID Present field can be included in the STA Control field of the Per-STA Profile subelement. The Group-managing AP MLD ID Present field can indicate whether the Group-managing AP MLD ID for the AP corresponding to the Link ID is included in the Link Info field. The Group-member AP MLD ID Present field may indicate whether the Group-member AP MLD ID for the AP corresponding to the Link ID is included in the Link Info field. In this case, the Group-managing AP MLD ID and/or the Group-member AP MLD ID may be included in the STA Info field or the STA Profile field. When the Group-managing AP MLD ID and the Group-member AP MLD ID are included in the Link Info field, information about APs affiliated with multiple Group-member AP MLD IDs may be provided.

For example, when information is provided about APs affiliated with the same Group-member AP MLD, the Group-member AP MLD ID may be included in the Common Info field and not in the Link Info field. Therefore, this case can reduce overhead compared to when the Link Info field necessarily includes the Group-member AP MLD ID.

For example, if the Group-member AP MLD ID is unique within a Group-member AP MLD, the Group-member AP MLD ID may be omitted if the Group-member AP MLD ID is 0. This means that an AP receiving a multi-link probe request without a Group-member AP MLD ID can implicitly identify that the request is a request for information of another AP regarding its own Group-member AP MLD.

For example, if the Common Info field includes the Group-managing AP MLD ID and the Group-member AP MLD ID, this can imply that information of APs corresponding to the same Group-member AP MLD ID is being requested. In this case, the Link Info field may not include the Group-managing AP MLD ID and the Group-member AP MLD ID. Accordingly, the Group-managing AP MLD ID Present field and the Group-member AP MLD ID Present field may not be included in the Link Info field.

In some implementations, if the existing AP MLD ID is used for the Group-member AP MLD, the Group-managing AP MLD ID may be included in the Common Info field and/or the Link Info field of the Basic Multi-Link element, as follows:

### D-1) Included in the Common Info Field

This method may be applied when a multi-link probe request including the Group-managing AP MLD ID is transmitted according to the method “C-1) Included in the Common Info Field” above.

According to this method, the Present Bitmap subfield of the Basic Multi-Link element may include the Group-managing AP MLD ID Present field. The Group-managing AP MLD ID Present field may indicate whether the Common Info field includes the Group-managing AP MLD ID. Accordingly, the Group-managing AP MLD ID may be included in the Common Info field. If the Group-managing AP MLD ID is included in the Common Info field, the multi-link probe response can only provide information about APs affiliated with the same Group-member AP MLD ID and the same Group-managing AP MLD ID.

### D-2) Included in the Link Info Field—Always Present

This method can be applied when a multi-link probe request including the Group-managing AP MLD ID is transmitted according to the method “C-2) Included in the Link Info Field—Always Present” above.

According to this method, the Group-managing AP MLD ID for the AP corresponding to the link ID of each Per-STA Profile subelement can be included in the STA Control field of the corresponding Per-STA Profile subelement. If the Group-managing AP MLD ID is included in the Link Info field, information about APs affiliated with multiple AP MLD IDs can be provided. However, if information is provided for APs affiliated with the same AP MLD ID, including the Group-managing AP MLD ID in the Link Info field may incur greater overhead than including it in the Common Info field.

### D-3) Included in the Link Info Field—Not Always Present

This method can be applied when a multi-link probe request containing a Group-managing AP MLD ID is transmitted according to the method described in “C-3) Included in the Link Info Field—Not Always Present” above.

According to this method, the Group-managing AP MLD ID Present field can be included in the STA Control field of the Per-STA Profile subelement. The Group-managing AP MLD ID Present field can indicate whether the Group-managing AP MLD ID for the AP corresponding to the Link ID is included in the Link Info field. In this case, the Group-managing AP MLD ID can be included in the STA Info field or the STA Profile field. If the Group-managing AP MLD ID is included in the Link Info field, information about APs affiliated with multiple AP MLD IDs can be provided.

For example, if information about APs affiliated with the same AP MLD ID is provided, the Group-managing AP MLD ID can be included in the Common Info field and not in the Link Info field. Therefore, this case can reduce overhead compared to when the Group-managing AP MLD ID is necessarily included in the Link Info field.

For example, if the Group-managing MLD ID is unique in the network, the Group-managing AP MLD ID may be omitted if the Group-managing AP MLD ID is 0. That is, an AP receiving a multi-link probe request without a Group-managing AP MLD ID can implicitly identify that the request is a request for information about other Group-member AP MLDs for the Group-managing AP MLD to which it belongs and/or information about APs affiliated with that Group-member AP MLD.

For example, if the Common Info field includes the Group-managing AP MLD ID, it may imply that information about APs corresponding to the same Group-managing AP MLD ID is being requested, in which case the Link Info field may not include the Group-managing AP MLD ID. Accordingly, the Group-managing AP MLD ID Present field may also not be included in the Link Info field.

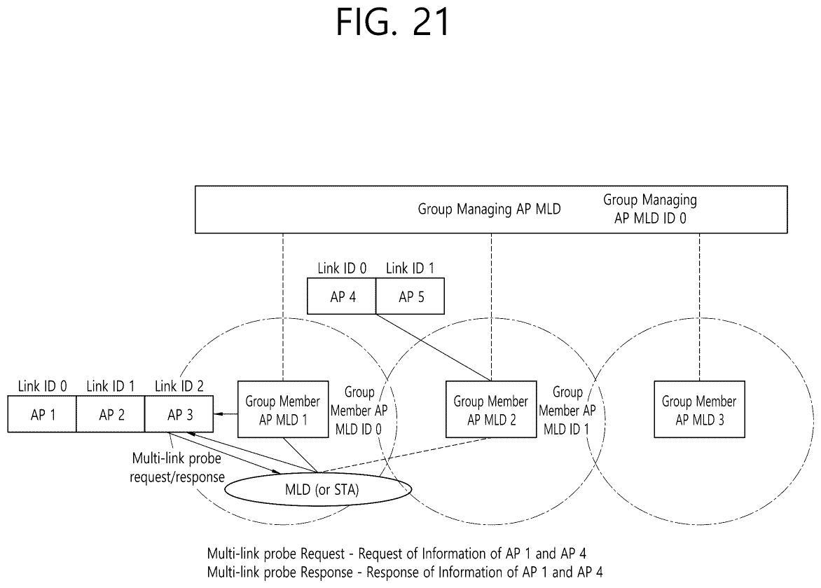

FIG. 21 shows an example of a multi-link probe request/response based on the Group-managing AP MLD ID and/or the Group-member AP MLD ID, according to an embodiment of the present disclosure.

Referring to FIG. 21, an MLD/STA may request information about AP 1 and AP 4 to AP 3, which belongs to Group-member AP MLD 1, via a multi-link probe request. Since the multi-link probe request includes the Group-managing AP MLD ID 0 and the Group-member AP MLD ID 0 for AP 1, and the Group-managing AP MLD ID 0 and the Group-member AP MLD ID 1 for AP 4, the multi-link probe request requests information about APs belonging to other Group-member AP MLDs belonging to the same Group-managing AP MLD. Therefore:
For Method A-1/A-3, the Group-member MLD ID may not be present in the Common Info field of the multi-link probe request frame. Additionally, the Per-STA profile subelement for AP 1 may include the Group-member AP MLD ID 0, and the Per-STA profile subelement for AP 4 may include the Group-member AP MLD ID 1.
For Methods B-1/B-3, the Group-managing AP MLD ID may not be present in the Common Info field of the multi-link probe request frame.

Although the Link ID for AP 1 and the Link ID for AP 4 are both 0, the combinations of (Group-managing AP MLD ID, Group-member AP MLD ID) for the corresponding APs are different (i.e., Group-managing AP MLD ID 0 and Group-member AP MLD ID 0 for AP 1, Group-managing AP MLD ID 0 and Group-member AP MLD ID 1 for AP 4), so AP 1 and AP 4 can be distinguished by the Group-managing AP MLD ID and/or Group-member AP MLD ID.

Similarly, AP 3 can provide information about AP 1 and AP 4 via a multi-link probe response. In this case:
For Methods C-1/C-3, the Group-member AP MLD ID may not be present in the Common Info field of the multi-link probe response frame. Additionally, the Per-STA profile subelement for AP 1 may include the Group-member AP MLD ID 0, and the Per-STA profile subelement for AP 4 may include the Group-member AP MLD ID 1.
For Method D-1/D-3, the Group-managing AP MLD ID may not be present in the Common Info field of the multi-link probe response frame.

### IV. Use of Group ID for DS-STA-NOTIFY

While the MLD/STA is roaming from Group-member AP MLD 1 to Group-member AP MLD 2, the MLD/STA may receive data frames from at least one AP in the currently associated Group-member AP MLD 1. That is, until the MLD/STA is associated with Group-member AP MLD 2, the APs in Group-member AP MLD 2 may not transmit data frames. If all Group-member AP MLDs in an AP MLD domain receive data frames for their respective MLD/STA from the distributed system (DS), it may be possible for APs in Group-member AP MLD 2 to transmit data frames even before the MLD/STA is associated with Group-member AP MLD 2. However, it may be inefficient for all Group-member AP MLDs in the AP MLD domain to receive data frames for their respective MLD/STA from the DS. Therefore, it is possible to consider allowing MLDs/STAs to receive data frames from APs in Group-member AP MLD 1 until roaming is triggered. Therefore, if roaming is triggered, a method is needed to also receive data frames from APs in Group-member AP MLD 2, the target Group-member AP to which roaming is performed.

The DS can map which STA is associated with which Group-member AP MLD through the DS-STA-NOTIFY.request from the Group-managing AP MLD. This allows the DS to forward data to the Group-member AP MLD to which the MLD/STA is associated. <Table 9> shows the primitive parameters of DS-STA-NOTIFY.request.

TABLE 9

| Name | Type | Valid Range | Description |
|---|---|---|---|
| STAAddress | MAC | Any valid | When generated by an AP, |
| | address | individual | specifies the address of |
| | | MAC address | the STA whose association |
| | | | status with the AP has |
| | | | changed. When generated |
| | | | by an AP MLD. specifies |
| | | | the MLD address of the |
| | | | non-AP MLD whose |
| | | | association status with the |
| | | | AP MLD has changed. |
| | | | When generated by a mesh |
| | | | gate, specifies the address |
| | | | of the mesh STA whose |
| | | | reach-ability status |
| | | | through the mesh gate has |
| | | | changed. |
| UpdateType | Enumeration | ADD, MOVE, | Specifies the DS mapping |
| | | DELETE | update operation to be |
| | | | performed. |

Therefore, in order to transmit data to each AP in a Group-member AP MLD located in multiple locations within a Group-managing AP MLD, a Group-member AP MLD ID (or AP MLD ID) may be added to the primitive parameter of the DS-STA-NOTIFY.request. That is, MILD/STA data may be transmitted from the DS only to APs in the Group-member AP MILD mapped to the Group-member AP MILD ID (or AP MLD ID) in the AP MILD. In various embodiments, the primitive parameter of the DS-STA-NOTIFY request may be configured in the following manner:
A list of Group-member AP MILD IDs (or AP MLD IDs) as an additional parameter: The DS may transmit data to APs in the Group-member AP MLD corresponding to the listed Group-member AP MILD IDs (or AP MLD IDs).
Newly configuring a temporary DS-STA-NOTIFY.request: A new temporary DS-STA-NOTIFY.request is added to temporarily receive data from the DS until the MLD/STA is associated with the APs of the target Group-member AP MLD to which roaming is performed. The DS-STA-NOTIFY.request and temporary DS-STA-NOTIFY.request may be configured by adding the Group-member AP MLD ID (or AP MLD ID) to the existing primitive parameters.

To update this mapping, the MLD/STA may send a request comprising at least one of the following information to the APs of the Group-member AP MLD before roaming (e.g., the AP of Group-member AP MLD 1 in FIG. 16) and/or the APs of the target Group-member AP MLD to which the STA is roaming (e.g., the AP of Group-member AP MLD 2 in FIG. 16):
Additional DS-STA-NOTIFY indication: requests that data be transmitted additionally to the target Group-member AP MLD to which the STA is roaming via the DS.
Group-member AP MLD ID (or AP MLD ID): Indicates the Group-member AP MLD ID (or AP MLD ID) for which the DS-STA-NOTIFY will be updated. One or more Group-member AP MLD IDs (or AP MLD IDs) may be indicated.

The above-described information may be transmitted in a management frame/management action frame.

Various embodiments of the present disclosure can also be applied to EHT/UHR. For example, the group-managing AP MLD may be a UHR AP MLD, and the group member AP MLD may be an EHT AP MLD. Accordingly, the group-managing AP MLD ID may be a UHR AP MLD ID, and the group member AP MLD ID may be an EHT AP MLD ID.

The technical features of the present disclosure described above can be applied to various devices and methods. For example, the technical features of the present disclosure described above can be performed/supported by the devices of FIG. 1 and/or FIG. 5. For example, the technical features of the present disclosure described above can be applied only to a part of FIG. 1 and/or FIG. 5. For example, the technical features of the present disclosure described above can be implemented based on the processing chips 114, 124 of FIG. 1, or implemented based on the processors 111, 121 and the memories 112, 122 of FIG. 1, or implemented based on the processor 510 and the memory 520 of FIG. 5.

For example, the processor 111, the processing chip 114 of FIG. 1 and/or the processor 510 of FIG. 5 may be configured to execute instructions stored in the memory 112, 520 to implement the method performed by the mobile device in the present disclosure. The method comprises: performing an association procedure with a first access point (AP) affiliated with a first multi-link device (MLD); obtaining a group identifier (ID) of a roaming group including the first MLD; transmitting a request frame requesting roaming to a second MLD included in the roaming group, the request frame including the group ID; and performing a roaming to the second MLD based on receiving a response frame including the group ID.

For example, the processor 121 and/or processing chip 124 of FIG. 1 may be configured to execute instructions stored in the memory 122 to implement the method performed by the AP affiliated with the first MLD in the present disclosure. The method comprises: performing an association procedure with a mobile device; transmitting a group identifier (ID) of a roaming group including the first MLD to the mobile device; receiving, from the mobile device, a request frame requesting roaming to a second MLD included in the roaming group, the request frame including the group ID; and transmitting a response frame including the group ID to the mobile device so that the mobile device performs a roaming to the second MLD.

The technical features of the present disclosure can be implemented based on a computer readable medium (CRM) (e.g., non-transitory CRM). For example, the CRM in the present disclosure may comprise at least one CRM having stored thereon a program code implementing instructions executed by at least one processor.

For example, the CRM may be the memory 112 of FIG. 1, the memory 520 of FIG. 5, and/or a separate external memory/storage medium/disk. The CRM may store instructions that implement the method performed by the mobile device in the present disclosure based on being executed by a processor (e.g., the processor 111, the processing chip 114 of FIG. 1, and/or the processor 510 of FIG. 5). The method comprises: performing an association procedure with a first access point (AP) affiliated with a first multi-link device (MLD); obtaining a group identifier (ID) of a roaming group including the first MLD; transmitting a request frame requesting roaming to a second MLD included in the roaming group, the request frame including the group ID; and performing a roaming to the second MLD based on receiving a response frame including the group ID.

For example, the CRM may be the memory 122 of FIG. 1 and/or a separate external memory/storage medium/disk. The CRM may store instructions that implement the method performed by the AP affiliated with the MLD in the present disclosure based on being executed by a processor (e.g., the processor 121 and/or the processing chip 124 of FIG. 1). The method comprises: performing an association procedure with a mobile device; transmitting a group identifier (ID) of a roaming group including the first MLD to the mobile device; receiving, from the mobile device, a request frame requesting roaming to a second MLD included in the roaming group, the request frame including the group ID; and transmitting a response frame including the group ID to the mobile device so that the mobile device performs a roaming to the second MILD.

The foregoing technical features of this disclosure are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The present disclosure may have various advantageous effects.

For example, when a non-AP MLD roams, it can check whether the target AP MLD is included in the same roaming group as the AP MLD with which the non-AP MLD has currently established a link, and the number of APs to which roaming can be performed can be increased.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus, and technical features in method claim(s) and apparatus claim(s) can be combined to be implemented or performed in a method.

1. A method comprising:
performing an association procedure with a first access point (AP) affiliated with a first multi-link device (MLD);
obtaining a group identifier (ID) of a roaming group including the first MLD;
transmitting a request frame requesting roaming to a second MLD included in the roaming group, the request frame including the group ID; and
performing a roaming to the second MLD based on receiving a response frame including the group ID.

2. The method of claim 1, wherein the performing of the roaming to the second MLD comprises:
establishing a link with a second AP affiliated with the second MLD; and
releasing a link with a first AP affiliated with the first MLD.

3. The method of claim 2, wherein the link with the first AP is released after the link with the second AP is established.

4. The method of claim 1, wherein a mobile device performing the method maintains an associated state during and after the roaming is performed.

5. The method of claim 1, wherein the roaming group includes MLDs between which roaming can be performed.

6. The method of claim 1, wherein the group ID is obtained by receiving a management frame including at least one of a reduced neighbor report (RNR) element or a Basic Multi-Link element, and
wherein the group ID is included in at least one of the RNR element or the Basic Multi-Link element.

7. The method of claim 1, wherein the request frame is a probe request frame including a probe request multi-link element, and
wherein the group ID is included in at least one of a Common information (Info) field or a Link Info field in the probe request multi-link element.

8. The method of claim 1, wherein the response frame is a probe response frame including a Basic Multi-link element, and
wherein the group ID is included in at least one of a Common Info field or a Link Info field in the Basic Multi-link element.

9. The method of claim 8, wherein at least one of the Common Info field or the Link Info field further includes a subfield indicating whether the group ID is present.

10. The method of claim 1, further comprising obtaining an ID of the second MLD,
wherein the group ID and the ID of the second MLD are obtained by receiving a management frame including at least one of a reduced neighbor report (RNR) element or a Basic Multi-link element, and
wherein the group ID and the ID of the second MLD are included in at least one of the RNR element or the Basic Multi-link element.

11. The method of claim 1, wherein the request frame is a probe request frame including a probe request multi-link element, and
wherein the group ID and an ID of the second MLD are included in at least one of a Common Info field or a Link Info field in the probe request multi-link element.

12. The method of claim 1, wherein the response frame is a probe response frame including a Basic Multi-link element, and
wherein the group ID and an ID of the second MLD are included in at least one of a Common Info field or a Link Info field in the Basic Multi-link element.

13. The method of claim 12, wherein the group ID is included in the Common Info field, and the ID of the second MLD is included in the Link Info field.

14. The method of claim 12, wherein at least one of the Common Info field or the Link Info field includes a subfield indicating whether the group ID is present, and a subfield indicating whether the ID of the second MLD is present.

15. The method of claim 14, wherein the subfield indicating whether the group ID is present is included in the Common Info field, and the subfield indicating whether the ID of the second MLD is present is included in the Link Info field.

16. A mobile device comprising:
a transceiver;
a memory; and
at least one processor operatively coupled to the transceiver and the memory,
wherein the memory stores instructions that, based on being executed by the at least one processor, perform operations comprising:
performing an association procedure with a first access point (AP) affiliated with a first multi-link device (MLD);
obtaining a group identifier (ID) of a roaming group including the first MLD;
transmitting a request frame requesting roaming to a second MLD included in the roaming group, the request frame including the group ID; and
performing a roaming to the second MLD based on receiving a response frame including the group ID.

17-19. (canceled)

20. A first access point (AP) affiliated with a first multi-link device (MLD) comprising:
a transceiver;
a memory; and
at least one processor operatively coupled to the transceiver and the memory,
wherein the memory stores instructions that, based on being executed by the at least one processor, perform operations comprising:
performing an association procedure with a mobile device;
transmitting a group identifier (ID) of a roaming group including the first MLD to the mobile device;
receiving, from the mobile device, a request frame requesting roaming to a second MLD included in the roaming group, the request frame including the group ID; and
transmitting a response frame including the group ID to the mobile device so that the mobile device performs a roaming to the second MLD.
